(19) United States
(12) Patent Application Publication
(10) Pub. No.: US 2017/0140632 A1
(43) Pub. Date: May 18, 2017

(54) METHODS AND APPARATUS FOR MOUNTING A SENSOR FOR USE WITH AN ASSET TRACKING SYSTEM

(71) Applicant: W. W. Grainger, Inc., Lake Forest, IL (US)

(72) Inventors: Brice Klein, Chicago, IL (US); David Koenig, Lake Forest, IL (US); Steve Martinez, Lake Forest, IL (US); Reena Patel, Lake Forest, IL (US)

(21) Appl. No.: 15/353,512

(22) Filed: Nov. 16, 2016

Related U.S. Application Data
(60) Provisional application No. 62/262,508, filed on Dec. 3, 2015.
(60) Provisional application No. 62/255,640, filed on Nov. 16, 2015.

(51) Int. Cl. G08B 21/18

(52) U.S. Cl. CPC G08B 21/18

(57) ABSTRACT

An asset tracking system includes a series of sensors placed on a tool storage system connected to a computerized system. The sensor mounts are placed so that sensor can detect the presence or absence of the tool assigned to the spot. In some examples, these sensors are pressure sensors calibrated to detect the weight of the tool upon the tool mount. The system can remotely notify a user of the status of the tools through either a display or a telecommunications system. The system can also be configured in some examples to check tools out to a specific user via the computerized system.

### FIELD OF THE DISCLOSURE

The present disclosure relates generally to mounting a sensor to a storage place for an object and, more particularly, to various methods and apparatus for mounting a sensor for use with an asset tracking system.

### BACKGROUND OF RELATED ART

In many fields, equipment and inventory is tracked and its user and location monitored. This can be done manually or with the help of software. Many organizations have policies for checking out tools and returning those tools within certain windows. These policies endeavor to prevent the tools from getting lost or damaged. For example, a construction company might require someone to sign out a drill or a jackhammer and return it at the end of the job or their shift. Missing tools can cause work slowdowns and be costly to replace if the tool is lost or believed lost. Stored tools are less likely to be damaged accidentally, cause harm, or be used inappropriately.

Accordingly, there is a need to improve compliance with tool policies, by for example, displaying missing tools and notifying designated individuals of tools that have not been returned.

### BRIEF DESCRIPTION OF THE DRAWINGS

FIG. 1 is a block diagram illustrating components of an exemplary network system in which the methods described hereinafter may be employed;

FIG. 2 is a front isometric view of an example sensor mount according to the principles of this disclosure.

FIG. 3 is a rear isometric view of the sensor mount of FIG. 2.

FIG. 4 is a rear elevated view of the sensor mount of FIG. 2.

FIG. 5 is a side elevated view of the sensor mount of FIG. 2.

FIG. 6 is a bottom plan view of the sensor mount of FIG. 2.

FIG. 7 is a front elevated view of the sensor mount of FIG. 2.

FIG. 8 is a top plan view of the sensor mount of FIG. 2.

FIG. 9 is a top isometric view of another example sensor mount according to the principles of this disclosures.

FIG. 10 is a bottom isometric view of the sensor mount of FIG. 9.

FIG. 11 is a bottom plan view of the sensor mount of FIG. 9.

FIG. 12 is a side elevated view of the sensor mount of FIG. 9.

FIG. 13 is a side view of the sensor mount of FIG. 9 with a sensor and tool receiving portion.

FIG. 14 shows a plurality of sensor mounts on a pegboard with tools.

### DETAILED DESCRIPTION

The following description of example methods and apparatus is not intended to limit the scope of the description to the precise form or forms detailed herein. Instead the following description is intended to be illustrative so that others may follow its teachings.

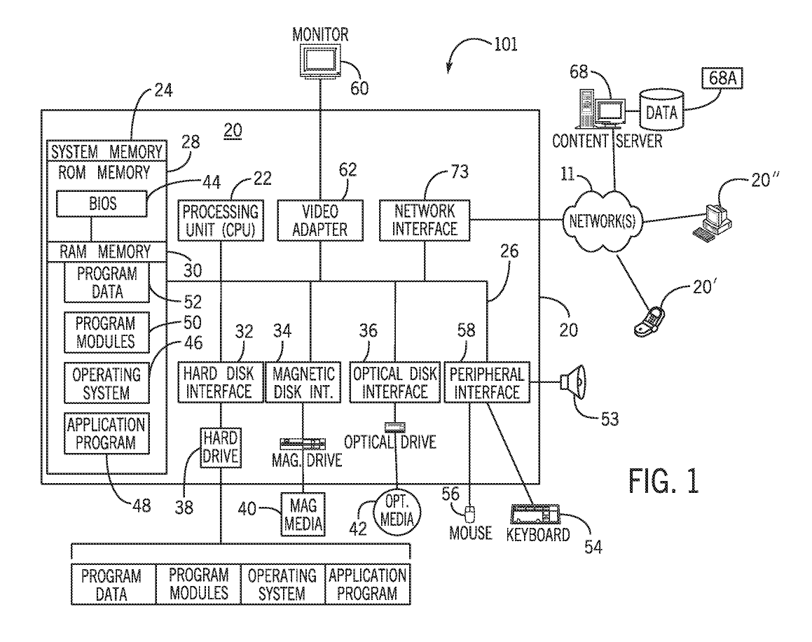

Turning to FIG. 1, an exemplary computing system comprised of a plurality of processing devices 20/68 linked via a network 12, such as a wide area network or the Internet, is illustrated. Processing devices 20, illustrated in the exemplary form of a device having conventional computer components, are provided with executable instructions to, for example, provide a means for a user to access a remote processing device, e.g., a third party server system 67, via the network 12 to, among other things, view electronic documents made available by such third party, to perform a search for products and/or services (individually and collectively referred to hereinafter as “products”), etc. Generally, the computer executable instructions reside in program modules which may include routines, programs, objects, components, data structures, etc. that perform particular tasks or implement particular abstract data types. Accordingly, those skilled in the art will appreciate that a processing device 20 may be embodied in any device having the ability to execute instructions such as, by way of example, a personal computer, mainframe computer, personal-digital assistant (“PDA”), cellular or smart telephone, tablet computer, or the like. Furthermore, while described and illustrated in the context of discrete processing devices 20, those skilled in the art will also appreciate that the various tasks described hereinafter may be practiced in a distributed or cloud-like environment having multiple processing devices linked via a local or wide-area network whereby the executable instructions, required data, etc. may be associated with and/or executed by one or more of multiple processing devices.

It will also be appreciated that, in the case of a user and/or the current location not having the ability to access to the Internet, a further device having all data and logic could communicate with the User's Computing Device via BlueTooth or any other protocol that makes sense to accomplish the various goals set forth herein.

For performing the various tasks in accordance with the executable instructions, a processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional, external memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser, electronic document viewer/editor, etc.), other program modules 50 (such as program extensions), and/or program data 52. Still further, any such computer-executable instructions may be downloaded to one or more of the computing devices as needed, for example, via a network connection.

A user may interact with the various application programs, etc. of a processing device 20, e.g., to enter commands and information into the processing device 20, through input devices such as a touch screen or keyboard 54 and/or a pointing device 56. While not illustrated, other input devices may include a microphone, a joystick, a game pad, a scanner, a camera, a gesture recognizing device, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

A processing device 20 may also utilize logical connections to one or more remote processing devices, such as vendor server system 68 having one or more associated data repositories 68A in which is stored, for example, product information and user information. In this regard, while the server system 68 has been illustrated in the exemplary form of a computer, it will be appreciated that the server system 68 may, like processing device 20, be any type of device having processing capabilities. Again, it will be appreciated that the server system 68 need not be implemented as a single device but may be implemented in a manner such that the tasks performed by the server system 68 and/or data needed for performance of such tasks are distributed to a plurality of processing devices linked through a communication network, e.g., implemented in the cloud. Additionally, the server system 68 may have logical connections to other third party server systems via the network 12 as needed and, via such connections, will be associated with data repositories that are associated with such other third party server systems.

For performing tasks, e.g., to support commerce related functionalities, the server system 68 may include many or all of the elements described above relative to the processing device 20. By way of further example, the server system 68 includes executable instructions stored on a non-transient memory device for, among other things, handling search requests, providing search results, accepting user ratings/comments information, for displaying user ratings/comments information, for handling orders for goods, for retrieving and providing inventory information, etc. Communications between the processing device 20 and the server system 68 may be exchanged via a further processing device, such as a network router, that is responsible for network routing. Communications with the network router may be performed via a network interface component 73. Thus, within such a networked environment, e.g., the Internet, World Wide Web, or other like type of wired or wireless network, it will be appreciated that program modules depicted relative to the processing device 20, or portions thereof, may be stored in the memory storage device(s) of the server system 68.

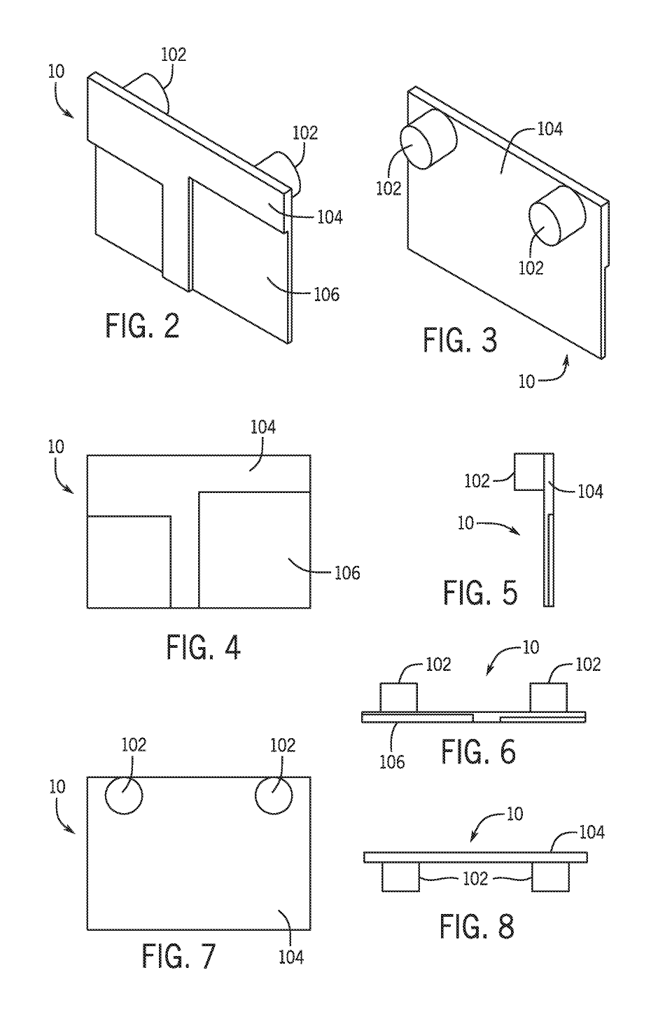

Referring now to the figures, and more particularly to FIGS. 1-3, an example sensor mount 10 is illustrated. In this instance, the example sensor mount 10 including a plate 104 and at least one nob 102. One of ordinary skill in the art will appreciate that the plate 104 could be made any suitable size or shape as desired in order to adapt the sensor mount 10 to a wide variety of locations and conditions. The example plate 104 serves as a foundation to the sensor mount 10 and provides solidity and structure to the sensor mount 10. It can therefore be made of many types of material with sufficient strength and stiffness to the device, such as for example, metal and/or a plastic materials.

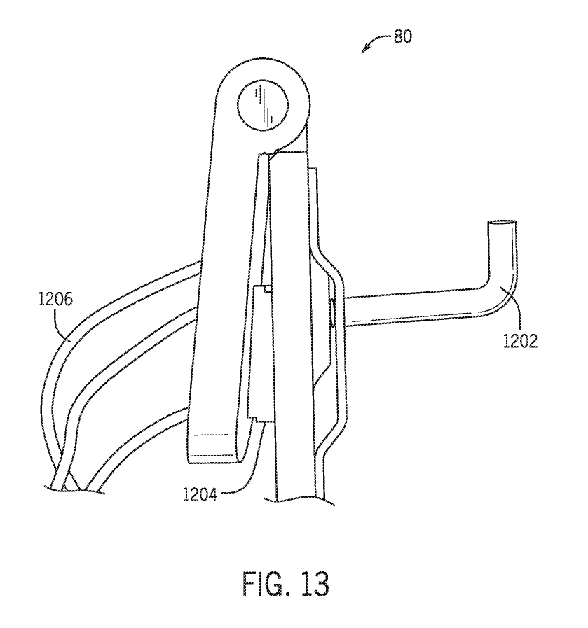

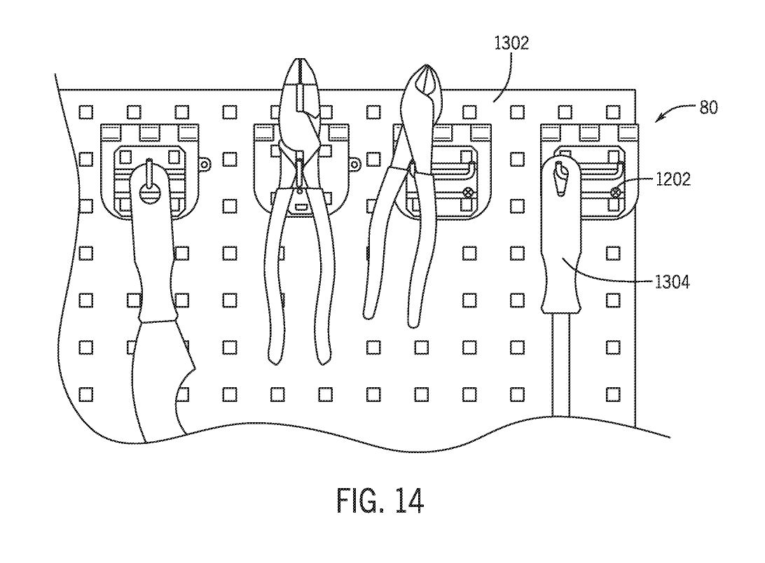

In this example, the nobs 102 are configured to work with any type of tool storage system, such as a hanging pegboard type tool storage system 80 such as that shown and described in FIG. 13 below. The example nobs 102 are adapted to clasp, fasten, mount, hang, or lock into the tool storage system 80. The nobs 102 allow for accurate and repeatable placement of the sensor mount 10 with respect to a tool storage system 80 giving accurate and reliable tool detection. In order to keep the sensor mount 10 secure, an adhesive, mechanical fastener, or the like can be applied to bind the mount to the tool storage system if desired by the user.

The nobs 102 of the illustrated example are adapted to align with a set of complimentary holes on a pegboard as is commonly known in the art. In one example of the present disclosure, the nobs 102 are spaced one inch apart in order to fit exactly into a standard pegboard. Specifically, in this example, the nobs have a diameter of ¼ in. (0.25) and a height of 3/16ths in. (0.1875 in.) in order to insure a align with a press fit. The nobs 102 could also be hooks or other projections adapted to fit within the tool storage system, such as the apertures shown in FIG. 13 below.

The rectangular plate 104 includes a recessed area 106. In this disclosure, the recessed area 106 is adapted to fit a sensor 1204, such as a proximity sensor, to ensure accurate alignment of the tool mount over the sensor mount 10. For example, the recessed area can account for the exact thickness the sensor to give a flush fit between the parts and ensuring a flat placement of the tool mount over the sensor. The rectangular plate may 104 also be adapted to contain and protect other parts, such as internal wiring or power sources, as needed. These parts may also be set into or enveloped by the rectangular plate 104 like the sensor 1204 is protect by recessed area 106.

The sensor 1204 is configured to interact with the tool mount and sense whether to tool is present in the support position of the tool mount. The sensor 1204 may be a pressure sensor or a proximity sensor, but will be understood by one of ordinary skill in the art that any suitable sensor including, for instance, a piezo-electric sensor, strain gauge, laser rangefinder, a temperature sensor, light sensor, RFID sensor, or any other device as desired to detect the presence of the tool in the mount.

The sensor mount 10 may be in operable communication with an asset tracking system. This asset tracking system may include multiple sensor mounts as well as a controller and memory, user interface, and display that can communicate to the user the status of their tools. The display, for example, may be as simple as lights next to the tool mount or as complicated as interactive screens so long as the user may be appraised of the appropriate information. In one example of the present disclosure, light emitting diodes illuminate whenever a tool is not present giving a visual impression of how many tools are missing.

The controller of the example asset tracking system may also include a microprocessor. This microprocessor includes the ability to remotely notify users of the status of the tools. This notification function can be used, for example, to email a manager what tools are still check out at the end of a set time, like the end of each shift. The notification can also be adapted to notify the user when a tool has been checked out for a period of time. The memory of the asset tracking system may be RAM or more permanent storage as would be appreciated by one of ordinary skill in the art. This memory may be used to record a log of interactions, tool usage, or any other information received by the asset tracking system.

In operation, the sensor mount 10 is place onto the pegboard and a tool mount is placed over it. When weighted by a tool, the tool mount contacts the sensor 1204 and triggers a signal to the asset tracking system. Upon receiving the signal, the microprocessor begins a counter. When the tool is returned, the sensor mount 10 sends a second signal to the microprocessor, which terminates count for that tool. The microprocessor constantly compares the count to a set value. When the count exceeds, the set value, the microprocessor triggers the notification to the user. For example the microprocessor can send an email or text message, trigger an audio or visual message, or the like. The microprocessor may have an internal clock. At certain times, the microprocessor will alert the user if any sensor mounts 10 have signaled that a tool has been removed and never signaled that the tool has been returned. For example, the triggering time can be every day at 5:00 pm or every 8 hours.

The asset tracking system may also comprise an identity tracking system and require that reach tool be assigned to a user. In one example, the user could access a tool check out system on a standard personal computer or hand held in operable communication with the asset tracking system that provides a unique identifier to the system. In another example, the user could have a unique identifier communicated by a simple transmitter or scannable identification. This could be an RFID tag, a magnetic strip card, or a Bluetooth communication as would understood by one of ordinary skill in the art. The controller of the asset tracking system can log the checked out tools under the nearest unique identifier provided by a user. This will provide a log as to who took a tool and enable the user to more reliably track down the location of the tools if they are misplaced.

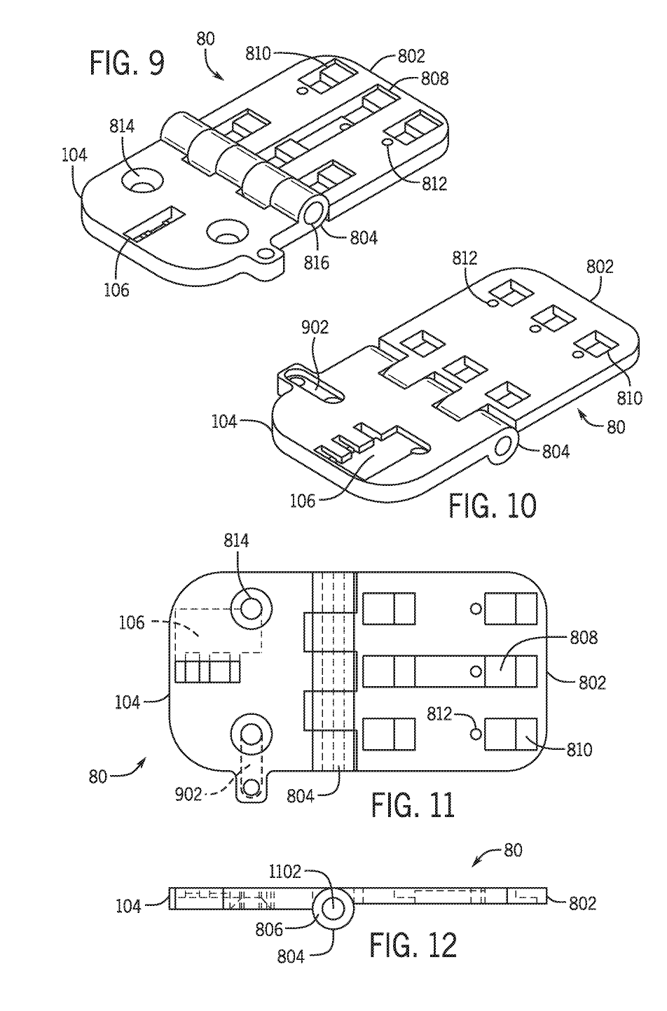

Another example of the sensor mount 10 is shown in FIGS. 8-11. Rather than be positioned under the tool mounting structure, this variant example is positioned between the tool storage system and the mount for the tool. This hinge variant sensor mount 80 has a plate 104 and upper portion 802 connected by a hinge 804. One of ordinary skill in the art will appreciate that the movable connection could also be accomplished by a translating plate, resilient section, or any other suitable hinge or pivot method. A mount for the tool is attached to the upper portion 802, while plate 104 is attached to the tool storage system 1302, shown as a pegboard below with respect to FIG. 13.

In this example, the plate 104 has the recessed area 106 adapted to fit a sensor 40. The recessed area 106 can pass all the way through the plate 104 to allow wires and thicker sensors to be accommodated. The upper portion 802 has a recessed striking area 808. The recessed striking area 808 is adapted to cooperate with the recessed area 106 to fully contain the sensor 1204. In this example, the upper portion 802 can sit flush on the plate 104 when the hinge 804 is fully rotated, because the sensor 1204 is completely enclosed within the hinge variant 80. The plate 104 may also have other areas to protect and contain other parts of the system such as a power source and connecting wires as necessary.

This upper portion 802 contains several mounting slots 810. The mounting slots are used to connect tool mounts 1202 to the sensor mount 80. These tool mounts 1202 can clip, friction fit, or be secured using bolts with a plurality of pilot holes 812 in the upper portion 808. It will be appreciated that the tool mount 1202 may be hooks, straps, magnets or any other method of holding a tool in a support position as desired by the user. One of ordinary skill in the art will appreciate that any sort of connection could be used to connect the tool mount 1202 to the upper portion 802 including but not limited to chemical adhesives, mechanical fasteners, or integrally forming the tool mount 1202 as part of the upper portion 802.

The plate 106 has a plurality of mounting holes 814 that can be used to affix the sensor mount 80 to a tool mounting system 1302. They can be used to receive screws, bolts, or any other method of connecting that one of ordinary skill might use. The mounting holes 814 may be partially sunk, beveled, or otherwise adapted to better connect to the tool mounting system 1302. The mounting holes 814 may also be slightly larger than necessary for the connector to simultaneously allow wires to pass through the mounting hole 814 from one side of the plate 106 to the other.

The hinge 804 in this example comprises complimentary hollow cylinders 816 in the plate 104 and the upper portion 802. When these hollow cylinders 816 are aligned, a pin 1102 can be inserted into cylinders 816 thereby rotatably joining the plate 104 and upper portion 802. In one example, the friction between the hollow cylinders and the pin is minimized by including hinge teeth. In yet another example, the pin 1102 is sized so that it is a slip-fit on all but one hinge tooth. In this example, the final hinge tooth is a press-fit. One of ordinary skill in the art will appreciate that friction could also be minimized through material choice, addition of lubricants, or other suitable means.

FIGS. 12-13 show an example of the sensor mount 10 in use. FIG. 12 shows the sensor mount 80 with a tool mount 1202 attached. The sensor 1204 is juxtaposed within the recessed area 106 to sit within the sensor mount 80. The sensor 1204 may be in operable communication with an asset tracking system. In this example, this is accomplished by connecting wires 1206 to the sensor 1204 and the asset tracking system. One of ordinary skill will appreciate that this connection could also be accomplished wirelessly as well using Wi-Fi, Bluetooth, radio, or any other suitable means of communication. In FIG. 13, a plurality of hinge variants 80 and attached tool mounts 1202 are affixed to a pegboard comprising tool mounting system 1302. Also shown in FIG. 13, the tool mount 1202 is adapted to bear a variety of tools 1304 as shown.

What is claimed is:

1. A mount for a tool sensor, comprising:
a controller having a memory containing at least one state regarding at least one tools;
a surface;
a support member extending from the surface;
a sensor operably connected to the controller;
wherein the sensor is configured to detect the presence of the at least one tool when the tool is in a support position and the controller and when the sensor detects a change in presence of the at least one tool changes, it causes the controller to send a signal indicating the change in at least one state.

2. The mount of claim 1, further comprising:
a first portion including the surface;
a second portion with the sensor is positioned within the second portion, and
a hinge connecting the first and second portions;
wherein the weight of the tool in the support position is detected by the sensor to determine the presence of the at least one tool when the tool is in a support position.

3. The mount of claim 1, further comprising at least one identity providing device providing a unique identifier to a user and a scanning apparatus operably coupled to the controller;
Wherein upon detection of the at least one identity providing device by the scanning device, the controller updates at least one state regarding at least one tool.

4. The mount of claim 3, wherein the controller reverts the at least one state regarding at least one tool if the sensor does not detect a change in the presence of the at least one tool.

5. The mount of claim 1 wherein the sensor detects the presence of the tool by the weight of the tool in the support position.

6. The mount of claim 1 wherein the support position further includes a tool receiving portion.

7. The mount of claim 6 wherein the support position is specifically shaped to hold a tool.

8. The mount of claim 6 wherein the surface is positioned between the tool receiving portion and a tool mounting system.

9. The mount of claim 6 wherein the tool receiving portion is attached to the surface.

10. The mount of claim 1 further comprising a mounting board with a plurality of mounting points; wherein the support member is adapted to fit into one of the plurality of mounting points.

11. The mount of claim 1 wherein the surface and support member are constructed of a plastic material.

12. The mount of claim 1 further comprise a plurality of offsets in the surface adapted to at least partially contain the sensor and position it flush with the surface.

13. The mount of claim 1 wherein the sensor is selecting from one of the following: a piezo-electric sensor, a strain gauge, a laser rangefinder, a temperature sensor, light sensor, and a RFID sensor.

14. A system with a mount for a tool sensor, comprising:
a surface of a quadrilateral polyhedron;
a mounting board with a plurality of mounting points;
a cylindrical support member extending perpendicularly from the surface, adapted to fit into the plurality of mounting points;
a plurality of offset sections set into the surface;
a sensor positioned within one of the plurality of offset sections configured to detect the presence of the at least one tool when the tool is in a support position; and
a controller operably connected to the sensor;
wherein when the sensor detects a change in presence of the at least one tool changes, the controller sends a signal to a display.

15. A mount for a tool sensor, comprising:
a top portion;
a tool mounting portion attached to the front of the top portion
a bottom portion connected to the top portion with a hinge and connected to a tool storage system through a plurality of apertures with a mechanical fastener;
a plurality of offset sections set into a surface of the bottom portion;
a sensor positioned within one of the plurality of offset sections configured to detect the presence of the at least one tool when the tool is in a support position; and
a controller operably connected to the sensor;
wherein when the sensor detects a change in presence of the at least one tool changes, the controller sends a signal to a display.
